(19) United States
(12) Patent Application Publication
(10) Pub. No.: US 2026/0217026 A1
(43) Pub. Date: Jul. 30, 2026

(54) LIQUID DISCHARGE HEAD AND IMAGE FORMING APPARATUS

(71) Applicant: Kengo HAMA, Kanagawa (JP)

(72) Inventor: Kengo HAMA, Kanagawa (JP)

(21) Appl. No.: 19/448,217

(22) Filed: Jan. 14, 2026

(30) Foreign Application Priority Data
Jan. 24, 2025 (JP) 2025-010367

(51) Int. Cl. B41J 2/14; B41J 2/175; B41J 2/20

(52) U.S. Cl. CPC B41J 2/14233; B41J 2/1433; B41J 2/175; B41J 2/20; B41J 2002/14306; B41J 2002/14419

(57) ABSTRACT

A liquid discharge head includes multiple nozzles, a liquid channel, a supply tank, and a supply port. The multiple nozzles discharge a liquid. The liquid channel communicates with the multiple nozzles, to flow the liquid through the liquid channel in a flow direction. The supply tank has a supply tank inlet to supply the liquid from the liquid channel into the supply tank and a supply tank outlet to discharge the liquid from the supply tank to the liquid channel toward the multiple nozzles in the flow direction. The supply port supplies the liquid to the supply tank inlet of the supply tank through the liquid channel. The supply tank is disposed between the supply port and the multiple nozzles in the liquid channel. The supply tank inlet is disposed below the supply tank outlet in a gravity direction.

### CROSS-REFERENCE TO RELATED APPLICATION

This patent application is based on and claims priority pursuant to 35 U.S.C. § 119(a) to Japanese Patent Application No. 2025-010367, filed on Jan. 24, 2025, in the Japan Patent Office, the entire disclosure of which is hereby incorporated by reference herein.

### BACKGROUND

### Technical Field

The present disclosure relates to a liquid discharge head and an image forming apparatus including the liquid discharge head.

### Related Art

In the related art, an image forming apparatus includes an inkjet head that discharges a liquid, such as ink, through a nozzle to form an image.

### SUMMARY

The present disclosure described herein provides an improved liquid discharge head including multiple nozzles, a liquid channel, a supply tank, and a supply port. The multiple nozzles discharge a liquid. The liquid channel communicates with the multiple nozzles, to flow the liquid through the liquid channel in a flow direction. The supply tank has a supply tank inlet to supply the liquid from the liquid channel into the supply tank and a supply tank outlet to discharge the liquid from the supply tank to the liquid channel toward the multiple nozzles in the flow direction. The supply port supplies the liquid to the supply tank inlet of the supply tank through the liquid channel. The supply tank is disposed between the supply port and the multiple nozzles in the liquid channel. The supply tank inlet is disposed below the supply tank outlet in a gravity direction.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a perspective view of a liquid discharge head;

FIGS. 2A and 2B are plan views of the liquid discharge head of FIG. 1, illustrating a nozzle configuration;

FIG. 3 is an enlarged view of a channel in the liquid discharge head of FIG. 1;

FIGS. 4A and 4B are schematic views of a liquid discharge head (module) of FIG. 3, illustrating occurrence of bubbles and movement of the bubbles in the liquid discharge head;

FIGS. 5A to 5E are schematic views of a liquid discharge head according to a comparative example;

FIGS. 6A to 6C are schematic views of a liquid discharge head, illustrating a state of bubbles drained in the liquid discharge head;

FIGS. 7A to 7C are schematic views of a damper structure;

FIG. 8 is a graph indicating a variation in pressure reduced by the damper structure of FIGS. 7A to 7C;

FIGS. 9A and 9B are schematic views of a liquid discharge head, illustrating a configuration of a curved portion and a bent portion in a channel;

FIGS. 10A and 10B are schematic views of a liquid discharge head, illustrating an effect of the curved portion of FIGS. 9A and 9B;

FIG. 11 is a diagram illustrating a configuration of a common channel substrate in a liquid discharge head;

FIG. 12 is a diagram illustrating a positional relationship between an individual channel and a nozzle hole in a liquid discharge head;

FIG. 13 is a schematic diagram illustrating a configuration, which is illustrated in FIG. 12, viewed in a Z direction;

FIG. 14 is a schematic view of a liquid discharge apparatus; and

FIG. 15 is a schematic view of a liquid discharge unit.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

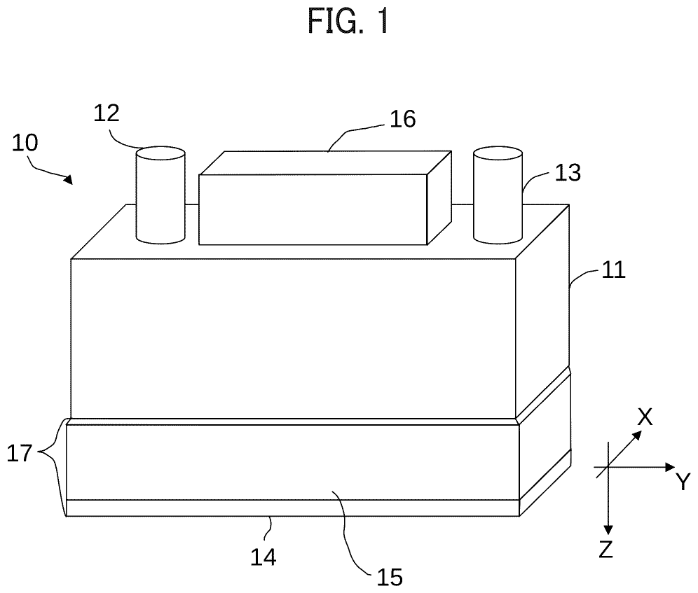

A liquid discharge head 10 as an inkjet head will be described below with reference to FIG. 1. In the following description, the direction in which nozzles are arrayed (longitudinal direction of the liquid discharge head) is defined as a Y direction, the direction in which liquid is discharged through the nozzles (height direction of the liquid discharge head and direction of gravity) is defined as a Z direction, and the direction (transverse direction of the liquid discharge head) orthogonal to the Y direction and the Z direction is defined as an X direction.

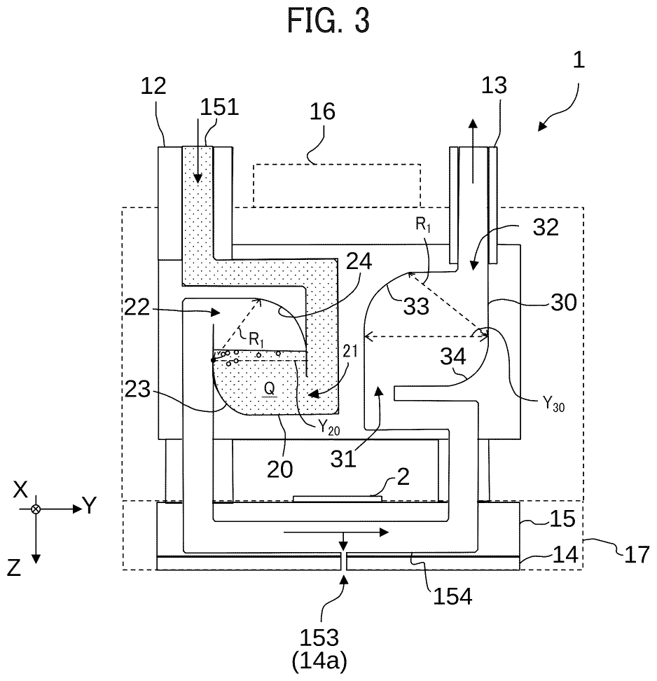

The liquid discharge head 10 includes a nozzle plate 14, a channel substrate (channel member) 15, and a cover 11 as a housing. The channel substrate 15 is disposed over the nozzle plate 14. A supply port 12, through which ink Q (see FIG. 3 and other drawings) as liquid is supplied from an outside of the liquid discharge head 10, is disposed at one end of the channel substrate 15 in the Y direction, and a drain port (discharge port) 13, through which the ink Q is drained (discharged) from the liquid discharge head 10, is disposed at the other end of the channel substrate 15 in the Y direction. The cover 11 is provided with a connector 16 for communicating with an actuator 2 accommodated in the cover 11 in an upper portion of the cover 11.

The nozzle plate 14, the channel substrate 15, and the cover 11 are made of metal, resin, or ceramic. The cover 11 accommodates and supports a liquid discharge module 1, which will be described later (refer to FIG. 3). The channel substrate 15 defines channels through which liquid flows, and the nozzle plate 14 has multiple nozzles from which liquid, such as recording liquid, is discharged. The nozzle plate 14 is mechanically fixed to the channel substrate 15, and the cover 11 is mechanically (detachably) attached to a base 17 that holds the channel substrate 15 and the nozzle plate 14.

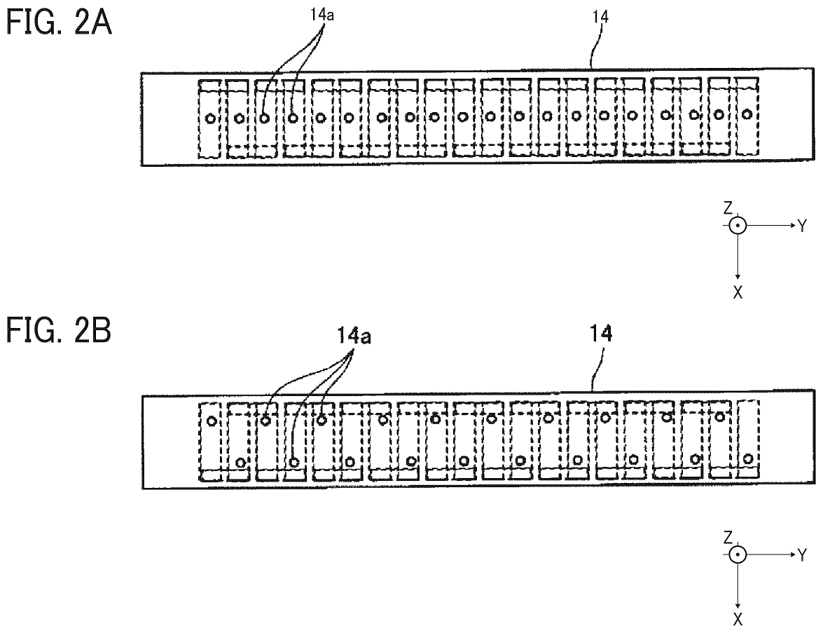

FIGS. 2A and 2B are diagrams each illustrating the arrangement of nozzles 14a of the nozzle plate 14. As illustrated in FIG. 2A, one nozzle array may be disposed at the center of the nozzle plate 14 in the X direction (the transverse direction of the liquid discharge head 10). Alternatively, as illustrated in FIG. 2B, two nozzle arrays, in which the nozzles 14a are arrayed in a staggered manner, may be disposed in the X direction. The arrangements of the nozzles 14a illustrated in FIGS. 2A and 2B are examples. For example, the nozzle plate 14 may have four nozzle arrays in total, i.e., two sets of two nozzle arrays are disposed in the X direction in a staggered manner. Alternatively, the nozzle plate 14 may have multiple nozzle arrays in which the nozzles 14a are arrayed at the same positions in the X direction (the transverse direction of the liquid discharge head 10).

The liquid discharge module 1 (the liquid discharge head 10) discharges the ink Q through each nozzle 14a. The ink Q as recording liquid is deposited on a recording medium (e.g., a sheet) based on image data from a controller to form an image on the recording medium. A description of the internal structure or configuration of each part of the liquid discharge module 1 is omitted, and the liquid discharge head 10 may have the structure of a typical inkjet head.

FIG. 3 is a schematic cross-sectional view of the liquid discharge module 1 including the channel substrate 15, illustrating the inner structure thereof. A liquid channel 151 as a supply channel is formed from the supply port 12 to the drain port 13 through the channel substrate 15.

A supply tank 20, a nozzle hole 153 as an opening formed at a contact position with the nozzle plate 14, a first liquid chamber 154 as a liquid chamber including the nozzle hole 153, and a collection tank 30 are disposed in the direction in which the ink Q flows along the liquid channel 151 (i.e., a flow direction). In FIG. 3, the most downstream side of the liquid channel 151 is connected to the drain port 13. In other words, the channel substrate 15 has the first liquid chamber 154 (i.e., a part of the supply channel) communicating with the nozzle hole 153.

In other words, the liquid channel 151 includes a first liquid channel connecting the supply port 12 and an inlet of the supply tank 20, a second liquid channel connecting an outlet of the supply tank 20 and the multiple nozzles 14a, a third liquid channel connecting the multiple nozzles 14a and an inlet of the collection tank 30, and a fourth liquid channel connecting an outlet of the collection tank 30 and the drain port 13.

The supply tank 20 is disposed upstream from the multiple nozzles 14a in the flow direction in the middle of the liquid channel 151, and the collection tank 30 is disposed downstream from the multiple nozzles 14a in the flow direction in another middle of the liquid channel 151.

In other words, the supply tank 20 is disposed between the supply port 12 and the multiple nozzles 14a in the liquid channel 151, and the collection tank 30 is disposed between the multiple nozzles 14a and the drain port (discharge port) 13 in the liquid channel (151).

The nozzle hole 153 is the opening disposed at the bottom of the first liquid chamber 154. The opening is aligned with the position of the nozzle 14a when the nozzle plate 14 is attached to the channel substrate 15. Although one nozzle hole 153 is illustrated in FIG. 3, multiple nozzle holes 153 may be formed in the Y direction as illustrated in FIG. 2A or 2B. When the multiple nozzle holes 153 are provided, actuators 2 are arrayed in the Y direction and operated to discharge liquid droplets through the nozzle holes 153 opposed to the actuators 2. The actuators 2 will be described below.

The drain port 13 is connected to, for example, an ink cartridge, which is disposed outside the liquid discharge head 10, to form a circulation loop through which the ink Q circulates from the collection side to the supply side.

The actuator 2, such as a piezoelectric element, is disposed above the first liquid chamber 154. The actuator 2 is opposed to the nozzle hole 153 and operated to change the volume of the first liquid chamber 154. As a result, the ink Q is discharged as liquid droplets through the nozzle hole 153, which is opposed to the actuator 2, downward in the Z direction. The actuator 2 is, but not limited to, the piezoelectric element. Any actuator that functions as a driving source to discharge the ink Q through the nozzle hole 153 can be used. The actuator 2 expands and contracts based on an electrical signal transmitted through the connector 16 to change the volume of the first liquid chamber 154. The electrical signal may be transmitted from a controller in the body of an image forming apparatus.

As illustrated in FIG. 3, the supply tank 20 has an inlet 21 (i.e., a supply tank inlet) at an upstream joint with the liquid channel 151 from the supply port 12. The supply tank 20 has an outlet 22 (i.e., a supply tank outlet) at a downstream joint with the liquid channel 151 leading to the first liquid chamber 154 communicating with the nozzle hole 153. The supply tank 20 includes a curved portion 23 on a wall face opposed to the inlet 21 and a curved portion 24 on an opposite wall face opposed to the outlet 22.

In other words, the supply tank 20 is disposed between the supply port 12 and the first liquid chamber 154 communicating with the nozzle hole 153 (nozzle 14a). The supply tank 20 has the outlet 22 communicating with the first liquid chamber 154 to supply (discharge) the liquid in the supply tank 20 to the first liquid chamber 154 and the inlet 21 below the outlet 22 in the direction of gravity (may be referred to as a gravity direction). The inlet 21 communicates with the supply port 12 to supply the liquid from the supply port 12 to the supply tank 20.

In still other words, the supply tank 20 is disposed above the channel substrate 15 in the gravity direction. The supply tank 20 stores the liquid to be supplied to the first liquid chamber 154. The supply port 12 is disposed above the supply tank 20 in the gravity direction. The supply port 12 supplies the liquid to the supply tank 20 through the inlet 21.

Similarly, the collection tank 30 has an inlet 31 (i.e., a collection tank inlet) at an upstream joint with the liquid channel 151 from the first liquid chamber 154. The collection tank 30 has an outlet 32 (i.e., a collection tank outlet) at a downstream joint with the liquid channel 151 leading to the drain port 13. The collection tank 30 includes a curved portion 33 on a wall face opposed to the inlet 31 and a curved portion 34 on an opposite wall face opposed to the outlet 32.

In other words, the collection tank 30 is disposed between the drain port 13 and the first liquid chamber 154 communicating with the nozzle hole 153 (nozzle 14a). The collection tank 30 has the outlet 32 communicating with the drain port 13 to drain (discharge) the liquid in the collection tank 30 to the drain port 13 and the inlet 31 below the outlet 32 in the direction of gravity. The inlet 31 communicates with the first liquid chamber 154 to collect the liquid from the first liquid chamber 154 to the collection tank 30.

In still other words, the collection tank 30 is disposed above the channel substrate 15 in the gravity direction. The collection tank 30 collects the liquid drained from the first liquid chamber 154. The drain port 13 is disposed above the collection tank 30 in the gravity direction. The drain port 13 drains (discharges) the liquid from the collection tank 30 through the outlet 32.

The curved portions 23 and 24 each form a curved wall face having a radius of curvature R₁. The radius of curvature R₁ may be set to any value but is preferably set to a value substantially equivalent to a width Y₂₀ of the supply tank 20 in the Y direction (i.e., a width direction of the supply tank 20).

The curved portions 33 and 34 each form a curved wall face having a radius of curvature R₁. The radius of curvature R₁ may be set to any value but is preferably set to a value substantially equivalent to a width Y₃₀ of the collection tank 30 in the Y direction (i.e., a width direction of the collection tank 30).

In other words, the radius of curvature R₁ is approximately equal to the width Y₂₀ and the width Y₃₀ (i.e., R₁≈Y₂₀≈Y₃₀).

Due to such a configuration, each edge or corner of the supply tank 20 and the collection tank 30 has a large curvature in a range in which the flow of the ink Q is not hindered. The edge or corner may cause bubbles in the supply tank 20 and the collection tank 30, but such a configuration facilitates the drainage of bubbles.

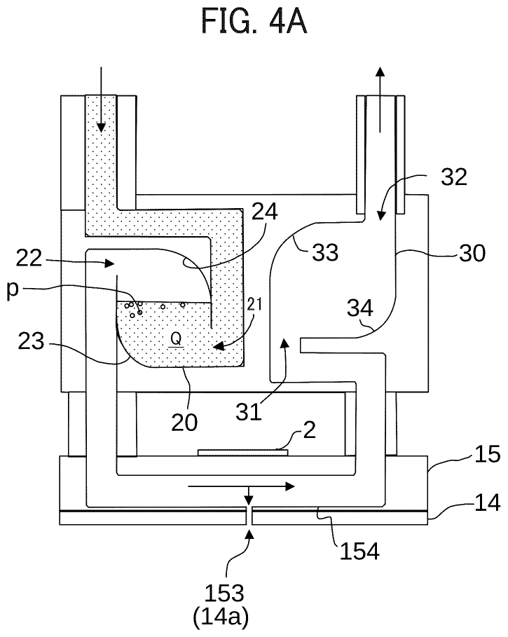

The inlet 21 is located below the outlet 22 in the Z direction, which is the direction of gravity. According to such a configuration, as illustrated in FIGS. 4A and 4B, bubbles p are unlikely to be generated. Even when bubbles p are generated, the generated bubbles p are likely to be drained through the outlet 22 along with the flow of the ink Q in the forward direction of the flow, as compared with a configuration according to a comparative example.

Similarly, in the collection tank 30, the inlet 31, which is connected to the liquid channel 151 from the first liquid chamber 154 communicating with the nozzle hole 153, is located below the outlet 32, which is connected to the liquid channel 151 leading to the drain port 13, in the direction of gravity.

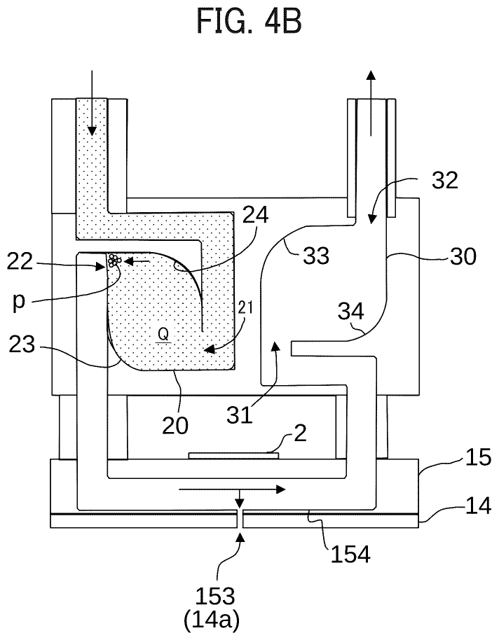

Such a point will be described below in detail. FIGS. 5A to 5E illustrate a supply ink tank 40 and a collection ink tank 50, which are disposed along the liquid channel 151, as ink tanks according to a comparative example. The liquid discharge module 1 typically has a tiny internal space, and it is difficult to arrange the liquid channel 151 in the tiny internal space. Thus, an inlet 41 is disposed on an upper portion of the supply ink tank 40.

In this case, as illustrated in FIGS. 5B and 5C, when the empty supply ink tank 40 is filled with the ink Q, an air pocket may be generated in an upper space in the supply ink tank 40, which may cause bubbles p to be generated. Further, since the supply ink tank 40 is connected to the straight liquid channel 151, the bubbles p generated in the liquid channel 151 stay close to the inlet 41 due to buoyancy.

When such bubbles p are merged into large bubbles p, as illustrated in FIGS. 5D and 5E, the large bubbles p occupy the upper space in the supply ink tank 40. Thus, sufficient pressure is difficult to apply because of, for example, a reduction in the flow rate of the ink Q, resulting in a lack of pressure at the nozzle hole 153 or defective formation of an image.

When an air pocket is generated in the upper space, the ink Q may be circulated backward to remove the bubbles p. However, the work of repetition of backward circulation and forward circulation causes an increase in initial filling time.

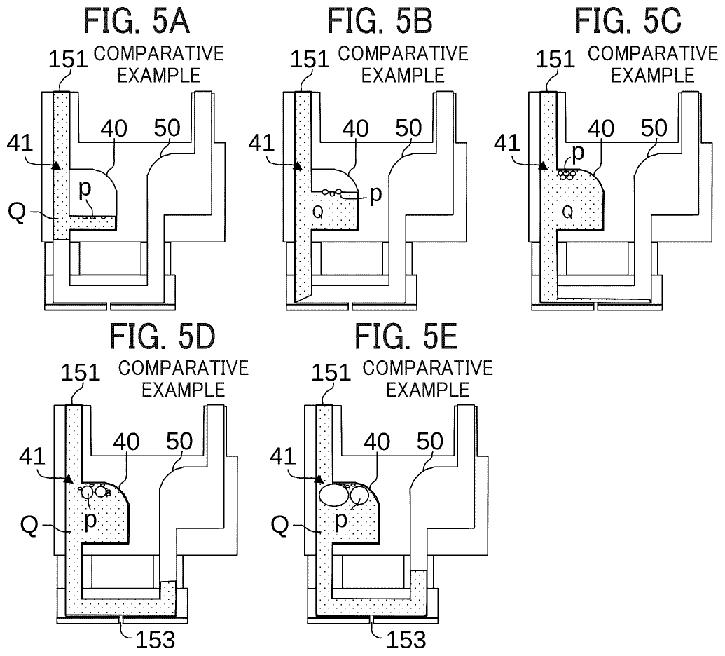

On the other hand, according to the configuration in the present embodiment, as illustrated in FIG. 3, the inlet 21 is located below the outlet 22. Thus, as illustrated in FIGS. 6A to 6C, even when bubbles p are generated while the supply tank 20 is filled with the ink Q, the bubbles p are likely to flow out of the supply tank 20 through the outlet 22.

Similarly, in the collection tank 30, the inlet 31 on the upstream side is located below the outlet 32. Thus, the generated bubbles p are likely to be drained from the collection tank 30 to the drain port 13 in the forward direction.

In other words, the supply tank 20 has the outlet 22 at the top of the supply tank 20, and the collection tank 30 has the outlet 32 at the top of the collection tank 30. According to such a configuration, an air pocket is unlikely to be generated when the supply tank 20 (or the collection tank 30) is filled with the ink Q. Even when bubbles p are generated, the generated bubbles p are unlikely to remain in the supply tank 20 (or the collection tank 30), and the bubbles p are likely to be drained by the forward circulation of the ink Q.

According to such a configuration, a tank disposed in the middle of the supply channel reduces a variation in pressure (pressure change), and bubbles p generated in the tank can be drained downstream by the forward circulation of liquid.

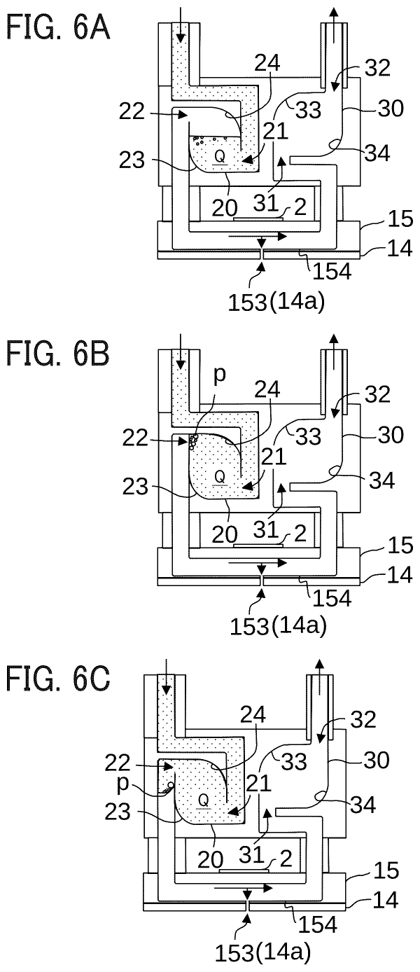

As illustrated in FIGS. 7A to 7C, the supply tank 20 and the collection tank 30 are each provided with a flexible cover 60 having a damper structure, which may be referred to simply as a damper. The damper structure has a cross section having a trapezoidal shape as viewed in a side cross-sectional view of the supply tank 20 or the collection tank 30. The respective flexible covers 60 of the supply tank 20 and the collection tank 30 have substantially the same configuration, and thus, in particular, the flexible cover 60 attached to the supply tank 20 will be described below.

As illustrated in FIGS. 7A to 7C, the supply tank 20 provided with the flexible cover 60 has a trapezoidal cross section as viewed in the side view of the supply tank 20. The flexible cover 60 has a wall face including an inclined face 61 that is inclined toward the outlet 22 as it goes upward in the direction of gravity. The wall face further includes an inclined face 62 that is inclined toward the inlet 21 as it goes downward on the other side, so that the shape of the supply tank 20 is symmetrical. The inclined face 61 and the inclined face 62 are straight in FIGS. 7A to 7C, but may be curved.

According to the flexible cover 60, even when a large amount of ink Q flows into the supply tank 20, as illustrated in FIGS. 7A to 7C, the flexible cover 60 deforms in ±X directions, so that the flow speed of the ink Q in the Z direction in the supply tank 20 is reduced to prevent a rapid pressure change. In other words, the flexible cover (i.e., the damper) is deformable in response to the pressure change in the supply tank 20 (or the collection tank 30)

Furthermore, since the wall face of the flexible cover 60 includes the inclined face 61 that is inclined toward the outlet 22 as it goes upward, a cross-sectional area S of a portion surrounded by the flexible cover 60 and the supply tank 20, which is diagonally shaded in FIGS. 7A to 7C, decreases toward the outlet 22 in the direction of gravity. In other words, each of the supply tank 20 and the collection tank 30 has a cross-sectional area surrounded by the damper on a plane orthogonal to the direction of gravity, and the cross-sectional area decreases upward in the direction of gravity. Thus, the volume of the portion surrounded by the supply tank 20 and the flexible cover 60 decreases upward. According to such a shape, the flow speed of the ink Q that flows in the Z direction inside the supply tank 20 (or the collection tank 30) increases toward the outlet 22 (or the outlet 32) to facilitate the drainage of bubbles.

Thus, the flexible cover 60 having the damper structure for the supply tank 20 (or the collection tank 30) has the trapezoidal shape in which the cross-sectional area of the upper portion decreases upward in the direction of gravity to facilitate the drainage of bubbles.

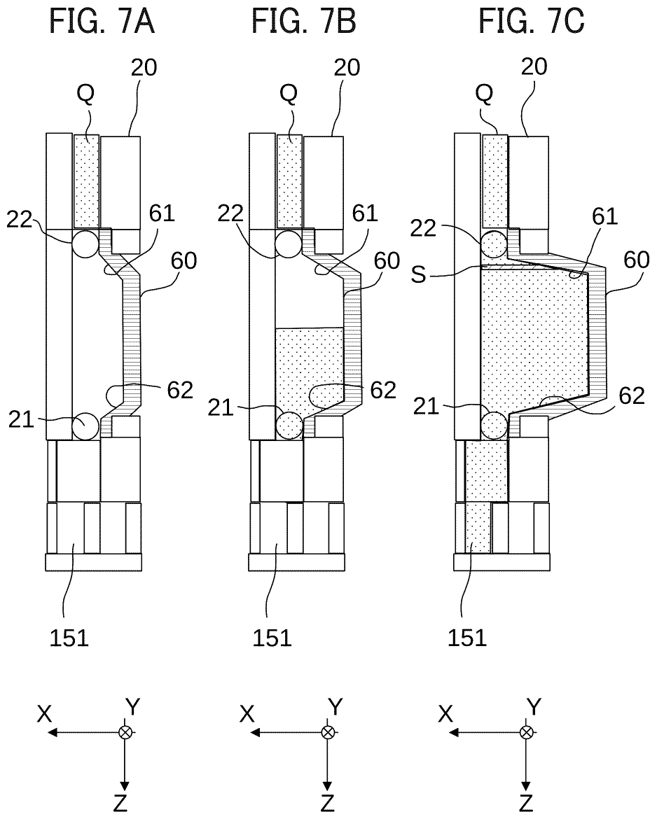

FIG. 8 is a graph illustrating the damper effect of the flexible cover 60. In FIG. 8, a case without the damper structure is indicated by the dashed line, and a case with the damper structure is indicated by the solid line. The horizontal axis indicates time, and the vertical axis indicates pressure. When the variation in pressure is 2460 Pa or more in absolute value, streaks are likely to be generated in printing. A threshold variation in pressure is indicated by the dot-and-dash line in FIG. 8.

As illustrated in FIG. 8, without the damper structure, the variation in pressure may exceed 2460 Pa in absolute value. When the variation in pressure exceeds 2460 Pa, streaks may be generated. However, with the flexible cover 60 having the damper structure, the variation in pressure is constantly reduced to less than 2460 Pa. Thus, streaks are prevented from being generated during the entire processing time.

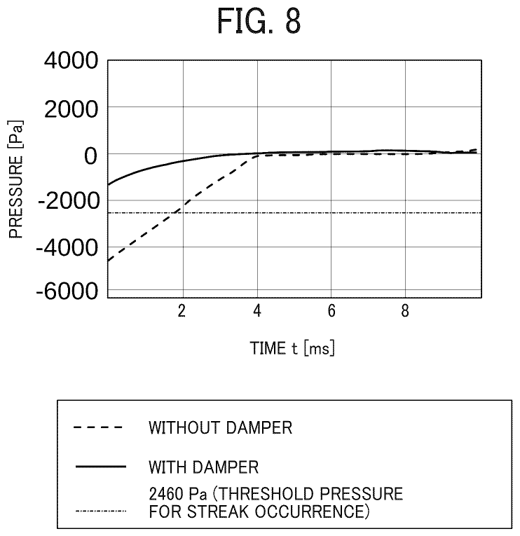

As illustrated in FIG. 9B, the bubbles p drained from the supply tank 20 due to the effect of the flexible cover 60 and the supply tank 20 move to the collection tank 30 through the first liquid chamber 154.

As described above, in the collection tank 30, the inlet 31 on the upstream side of the liquid channel 151 is located at an upper portion of the collection tank 30, and the outlet 32 is located at a lower portion of the collection tank 30. Similarly to the supply tank 20, the bubbles p are drained from the collection tank 30 to the drain port 13.

As illustrated in FIG. 9A, each corner or edge in the liquid channel 151 has a bent portion 151a formed on its corner or edge. The bent portion 151a has a bent wall face having a radius of curvature R₂ in cross section. In other words, the corner of the liquid channel 151 is rounded. Due to such a configuration, bubbles are not hindered, by edge or corner, from moving and passing through the liquid channel 151 to facilitate the drainage of the bubbles.

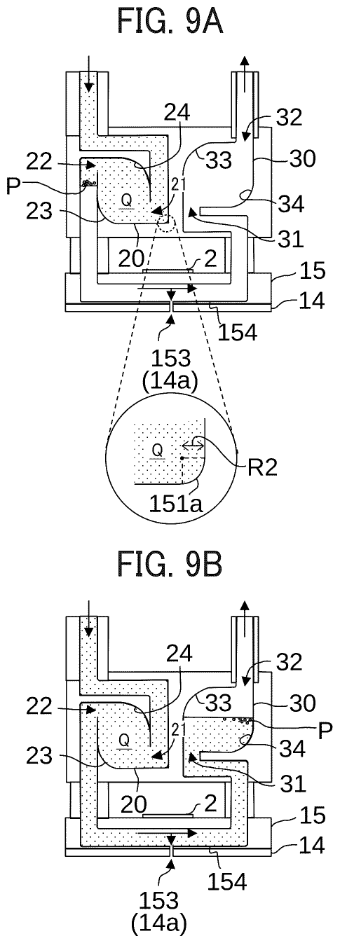

Each configuration described above is effective not only for initially filling tanks with the ink Q but also for draining the ink Q from tanks and cleaning the tanks, as illustrated in FIGS. 10A and 10B. Specifically, when the ink Q is drained by air flowing through the supply port 12, as illustrated in FIG. 10A as a comparative example, the ink Q may remain at edge or corner.

However, in the present embodiment, the curved portions 23 and 24, which are disposed at corners in the supply tank 20, have a curved face having the radius of curvature R₁. Accordingly, as illustrated in FIG. 10B, the ink Q is likely to gather toward the inlet 21 or the outlet 22 due to the curved portions 23 and 24. Thus, no ink Q remains at edge or corner. Furthermore, a lateral airflow flowing through the inlet 21 is turned upward along the curvature of the curved portion 23. Thus, the drainage of bubbles can be facilitated as compared with the comparative example, illustrated in FIG. 10A, with right-angled corners. The wall face of each bent portion 151a having curvature in the liquid channel 151 also achieves such an effect, and thus the description thereof will be omitted.

In the above description of the configuration of the liquid discharge module 1, for simplicity, the ink Q is discharged through the nozzle hole 153 opened in the first liquid chamber 154, but an embodiment of the present disclosure is not limited to such a configuration.

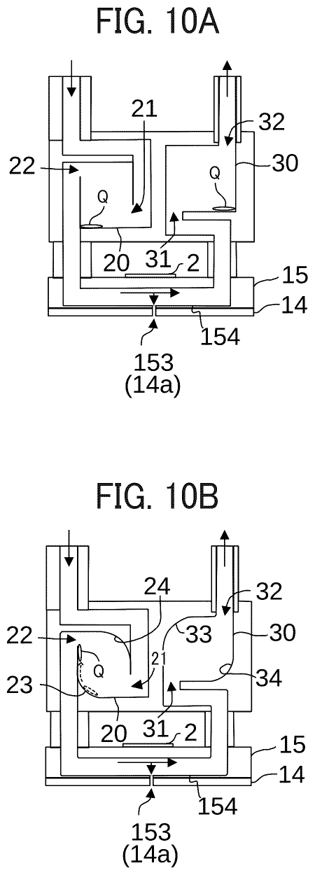

FIG. 11 illustrates a specific configuration of the channel substrate 15 of the liquid discharge module 1. The channel substrate 15 includes two upper structures 155 each including the first liquid chamber 154 therein, and a common channel substrate 156 at the bottoms of the upper structures 155. The common channel substrate 156 has grooves 157 that serve as channels for the ink Q connecting the two upper structures 155. The common channel substrate 156 has the nozzle holes 153 as openings at the bottom thereof, and the nozzle holes 153 respectively communicate with second liquid chambers 158 below.

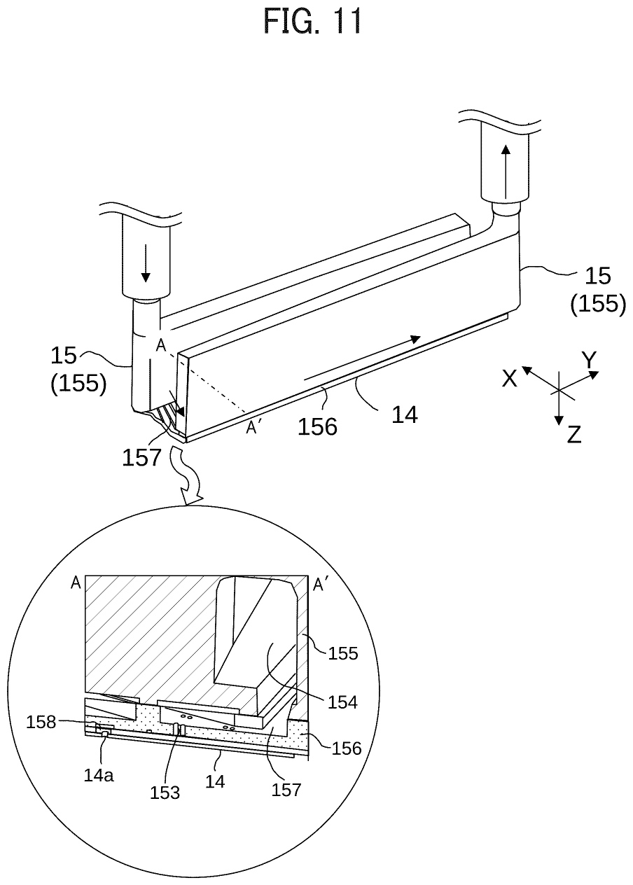

FIG. 12 is a perspective view of the common channel substrate 156, schematically illustrating the positional relationship between the configuration of the common channel substrate 156 and the second liquid chambers 158. A diaphragm 160 and an individual channel substrate 170 are disposed on one side of the common channel substrate 156 in the Z direction. Piezoelectric elements 161 are disposed side by side on the diaphragm 160 at the positions corresponding to the positions of the second liquid chambers 158.

The second liquid chambers 158 each serve as a small liquid chamber that functions as a reservoir for the ink Q. The piezoelectric elements 161 are disposed at the positions corresponding to the second liquid chambers 158, respectively. According to such a configuration, the ink Q is discharged from the nozzles 14a opened in the second liquid chambers 158 by the contraction and expansion of the volume of the second liquid chambers 158 when the corresponding piezoelectric elements 161 contract and expand.

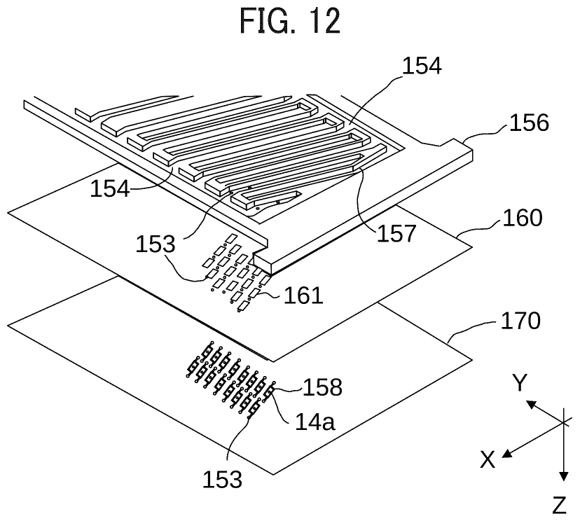

As illustrated in FIG. 12, the grooves 157 as branches on the common channel substrate 156 extend from the first liquid chambers 154 in a staggered manner. Channels are formed to connect the nozzles 14a to the staggered grooves 157. Accordingly, for example, when the liquid discharge module 1 is viewed in the Z direction as illustrated in FIG. 13, the ink Q flows from the first liquid chamber 154 on the left side toward the first liquid chamber 154 on the right side opposite the left side through the grooves 157 as branches. The nozzles 14a are opened on the channels. FIG. 13 schematically illustrates the flow of the ink Q in the channels indicated by the arrows.

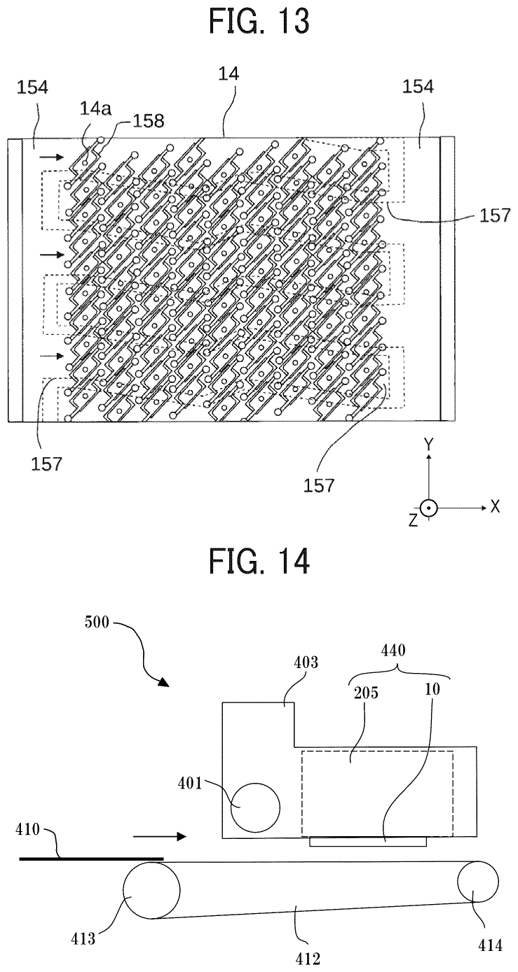

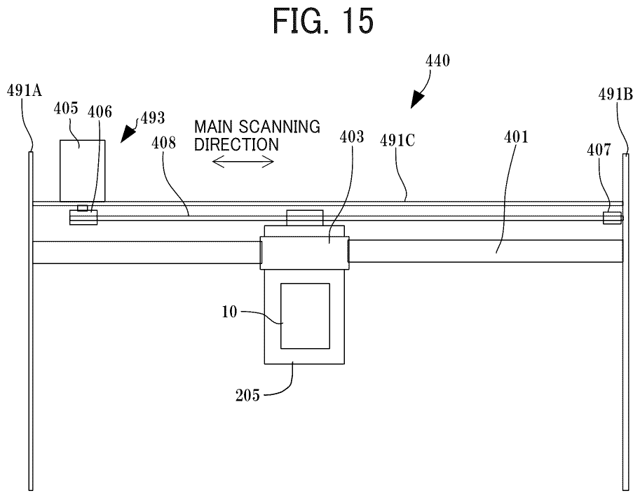

The liquid discharge head 10 can have various configurations, in addition to the above-described configuration as a specific configuration. The liquid discharge head 10 is used in various types of liquid discharge apparatuses, such as a printer 500 as an image forming apparatus illustrated in FIG. 14. An example of a printer will be described below with reference to FIGS. 14 and 15. FIG. 14 is a side view of a part of the printer 500. FIG. 15 is a plan view of the part of the printer 500.

The printer 500 is a serial type apparatus, and a main-scanning moving mechanism 493 illustrated in FIG. 15 reciprocally moves a carriage 403 in a main scanning direction. The main-scanning moving mechanism 493 includes, for example, a guide 401, a main scanning motor 405, and a timing belt 408. The guide 401 is bridged between left and right side plates 491A and 491B to movably hold the carriage 403. The main scanning motor 405 reciprocates the carriage 403 in the main scanning direction via the timing belt 408 looped around a drive pulley 406 and a driven pulley 407.

The carriage 403 mounts a liquid discharge unit 440 including a liquid discharge head 10 and an ink tank 205 to supply ink to the liquid discharge head 10. The liquid discharge head 10 of the liquid discharge unit 440 discharges color liquids of, for example, yellow (Y), cyan (C), magenta (M), and black (K) as the ink Q in accordance with the ink tank 205. The liquid discharge head 10 is mounted on the carriage 403 such that the nozzle array including multiple nozzles is arranged in the sub-scanning direction orthogonal to the main scanning direction. The liquid discharge head 10 discharges the color liquids downward (i.e., in the liquid discharge direction) from the multiple nozzles. The liquid discharge head 10 is coupled to the ink tank 205 to circulate and supply the ink Q of a desired color as described above.

The printer 500 includes a conveyance mechanism to convey a sheet 410 as a recording medium. The conveyance mechanism includes a conveyance belt 412 (i.e., a conveyor) and a sub-scanning motor to drive the conveyance belt 412.

The conveyance belt 412 attracts the sheet 410 and conveys the sheet 410 at a position facing the liquid discharge head 10. The conveyance belt 412 is an endless belt looped around a conveyance roller 413 and a tension roller 414. The sheet 410 can be attracted to the conveyance belt 412 by, for example, electrostatic attraction or air suction. The conveyance belt 412 circumferentially moves in the sub-scanning direction as the conveyance roller 413 is rotationally driven by the sub-scanning motor.

In the printer 500 having the above-described configuration, the sheet 410 is fed and attracted onto the conveyance belt 412 and conveyed in the sub-scanning direction by the circumferential movement of the conveyance belt 412.

The liquid discharge head 10 is driven in response to an image signal while the carriage 403 is moved in the main scanning direction to discharge a liquid onto the sheet 410 not in motion to form an image.

The liquid discharge unit 440 includes a housing, the main-scanning moving mechanism 493, the carriage 403, and the liquid discharge head 10 among components of the liquid discharge apparatus. The side plates 491A and 491B, and a back plate 491C construct the housing.

In the present disclosure, the liquid to be discharged is not limited to ink as long as the liquid has a viscosity or surface tension to be discharged from a head (liquid discharge head). However, preferably, the viscosity of the liquid is not greater than 30 millipascal-second (mPa·s) under ordinary temperature and ordinary pressure or by heating or cooling. More specifically, examples of the liquid to be discharged include a solution, a suspension, or an emulsion including, for example, a solvent, such as water or an organic solvent; a colorant, such as dye or pigment; a functional material, such as a polymerizable compound, a resin, or a surfactant; a biocompatible material, such as deoxyribonucleic acid (DNA), amino acid, protein, or calcium; and an edible material, such as a natural colorant. Such a solution, a suspension, or an emulsion can be used for, e.g., inkjet ink; surface treatment liquid; a liquid for forming an electronic element component, a light-emitting element component, or an electronic circuit resist pattern; or a material solution for three-dimensional fabrication.

Examples of an energy source for generating energy to discharge liquid include a piezoelectric actuator (a laminated piezoelectric element or a thin-film piezoelectric element), a thermal actuator that employs a thermoelectric transducer, such as a thermal resistor, and an electrostatic actuator including a diaphragm and opposed electrodes.

The “liquid discharge unit” is an assembly of parts relating to liquid discharge. The term “liquid discharge unit” represents a structure including the liquid discharge head and a functional component(s) or mechanism(s) combined with the liquid discharge head as a single unit. For example, the “liquid discharge unit” includes a combination of the liquid discharge head with at least one of a head tank, a carriage, a supply mechanism, a maintenance mechanism, a main-scanning moving mechanism, or a liquid circulation device.

The above integration may be achieved by, for example, a combination in which the liquid discharge head and a functional component(s) or mechanism(s) are fixed to each other through, e.g., fastening, bonding, or engaging, and a combination in which one of the liquid discharge head and the functional component(s) or mechanism(s) is movably held by the other. The liquid discharge head and the functional component(s) or mechanism(s) may be detachably attached to each other.

For example, the liquid discharge head and the head tank are integrated to form the liquid discharge unit as a single unit. Alternatively, the liquid discharge head and the head tank coupled (connected) to each other via, for example, a tube may form the liquid discharge unit as a single unit. A unit including a filter may further be added to a portion between the head tank and the liquid discharge head of the liquid discharge unit.

In another example, the liquid discharge unit may be an integrated unit in which a liquid discharge head is integrated with a carriage.

As yet another example, the liquid discharge unit is a unit in which the liquid discharge head and the main-scanning moving mechanism are combined into a single unit. The liquid discharge head is movably held by a guide that is a part of the main-scanning moving mechanism. The liquid discharge unit may include the liquid discharge head, the carriage, and the main-scanning moving mechanism that are integrated as a single unit.

In another example, a cap that forms a part of the maintenance mechanism is fixed to the carriage mounting the liquid discharge head so that the liquid discharge head, the carriage, and the maintenance mechanism are integrated as a single unit to form the liquid discharge unit.

Further, in still another example, the liquid discharge unit includes tubes connected to the liquid discharge head mounting the head tank or the channel component so that the liquid discharge head and the supply mechanism are integrated as a single unit. Through the tube, the liquid in a liquid storage source is supplied to the liquid discharge head.

The term “liquid discharge apparatus” used herein also represents an apparatus including the liquid discharge head or the liquid discharge unit to drive the liquid discharge head to discharge liquid. The term “liquid discharge apparatus” used herein includes, in addition to apparatuses to discharge liquid to a medium onto which liquid can adhere, apparatuses to discharge the liquid into gas (air) or a different liquid.

For example, the “liquid discharge apparatus” may further include devices relating to feeding, conveying, and ejecting of the medium onto which liquid can adhere and also include a pretreatment device and an aftertreatment device.

The “liquid discharge apparatus” may be, for example, an image forming apparatus to form an image on a sheet by discharging ink, or a three-dimensional fabrication apparatus to discharge fabrication liquid to a powder layer in which powder material is formed in layers to form a three-dimensional object.

The “liquid discharge apparatus” is not limited to an apparatus that discharges liquid to visualize meaningful images such as letters or figures. For example, the discharge apparatus may be an apparatus that forms patterns having no meaning or an apparatus that fabricates three-dimensional images.

The above-described term “medium onto which liquid can adhere” represents a medium on which liquid is at least temporarily adhered, a medium on which liquid is adhered and fixed, or a medium into which liquid adheres and permeates. Specific examples of the “medium onto which liquid can adhere” include, but are not limited to, a recording medium such as a paper sheet, recording paper, a recording sheet of paper, a film, or cloth, an electronic component such as an electronic substrate or a piezoelectric element, and a medium such as layered powder, an organ model, or a testing cell. The “medium onto which liquid can adhere” includes any medium to which liquid adheres, unless otherwise specified.

Examples of materials for the “medium onto which liquid can adhere” include any materials to which liquid can adhere even temporarily, such as paper, thread, fiber, fabric, leather, metal, plastic, glass, wood, and ceramic.

The term “liquid discharge apparatus” may be an apparatus in which the liquid discharge head and the medium onto which liquid can adhere move relative to each other. However, the liquid discharge apparatus is not limited to such an apparatus. For example, the liquid discharge apparatus may be a serial head apparatus that moves the liquid discharge head or a line head apparatus that does not move the liquid discharge head.

Examples of the liquid discharge apparatus further include: a treatment liquid applying apparatus that discharges a treatment liquid onto a sheet to apply the treatment liquid to the surface of the sheet, for reforming the surface of the sheet; and an injection granulation apparatus that injects a composition liquid, in which a raw material is dispersed in a solution, through a nozzle to granulate fine particles of the raw material.

The terms “image formation,” “recording,” “printing,” “image printing,” and “fabricating” used herein may be used synonymously with each other.

Aspects of the present disclosure are, for example, as follows.

### Aspect 1

According to Aspect 1, a liquid discharge head such as the liquid discharge head 10 includes: multiple nozzles to discharge a liquid; a supply channel communicating with the multiple nozzles; and a supply tank disposed in the supply channel. The supply tank is connected to an upstream side from the multiple nozzles in a flow direction of the liquid. The supply tank includes: an inlet through which the liquid flows from the supply channel into the supply tank; and an outlet through which the liquid is drained from the supply tank to the multiple nozzles. The inlet is located lower than the outlet in a direction of gravity.

In other word, a liquid discharge head includes multiple nozzles, a liquid channel, a supply tank, and a supply port. The multiple nozzles discharge a liquid. The liquid channel communicates with the multiple nozzles, to flow the liquid through the liquid channel in a flow direction. The supply tank has a supply tank inlet to supply the liquid from the liquid channel into the supply tank and a supply tank outlet to discharge the liquid from the supply tank to the liquid channel toward the multiple nozzles in the flow direction. The supply port supplies the liquid to the supply tank inlet of the supply tank through the liquid channel. The supply tank is disposed between the supply port and the multiple nozzles in the liquid channel. The supply tank inlet is disposed below the supply tank outlet in a gravity direction.

According to the above-described configuration, a variation in pressure is reduced by the tank disposed in the supply channel. Bubbles generated in the tank are drained downstream by forward circulation of the liquid. Thus, the variation in pressure due to the bubbles can be reduced, and print abnormality can be prevented.

### Aspect 2

According to Aspect 2, the liquid discharge head of Aspect 1, further includes a collection tank disposed in the supply channel. The collection tank is connected to a downstream side from the multiple nozzles in the flow direction of the liquid. The collection tank includes: an inlet through which the liquid flows from the supply channel into the collection tank; and an outlet through which the liquid is drained downstream from the collection tank. The inlet is located lower than the outlet in the direction of gravity.

In other words, the liquid discharge head according to Aspect 1, further includes a collection tank and a discharge port. The collection tank has a collection tank inlet to collect the liquid from the multiple nozzles into the collection tank through the liquid channel and a collection tank outlet to discharge the liquid from the collection tank to the liquid channel in the flow direction. The discharge port discharges the liquid from the liquid channel. The collection tank is disposed between the multiple nozzles and the discharge port in the liquid channel. The collection tank inlet is disposed below the collection tank outlet in the gravity direction.

According to the above-described configuration, a variation in pressure is reduced by the tank disposed in the supply channel. Bubbles generated in the tank are drained downstream by forward circulation of the liquid. Thus, the variation in pressure due to the bubbles can be reduced, and print abnormality can be prevented.

### Aspect 3

According to Aspect 3, the liquid discharge head of Aspect 2, further includes a nozzle plate and a channel member. The nozzle plate has the multiple nozzles to discharge the liquid downward from the multiple nozzles in the gravity direction. The channel member is disposed over the nozzle plate. The channel member has a liquid chamber, which is a part of the liquid channel, communicating with the multiple nozzles. The supply port is disposed above the supply tank in the gravity direction. The supply tank is disposed above the channel member in the gravity direction and stores the liquid to be supplied to the liquid chamber through the supply tank outlet.

### Aspect 4

According to Aspect 4, in the liquid discharge head of Aspect 3, the discharge port is disposed above the collection tank in the gravity direction. The collection tank is disposed above the channel member in the gravity direction and collects the liquid discharged from the liquid chamber through the collection tank inlet.

### Aspect 5

According to Aspect 5, in the liquid discharge head of Aspect 1 or 2, the supply tank and the collection tank each include a damper structure to prevent a rapid pressure change.

In other words, the supply tank includes a first damper, and the collection tank includes a second damper. The first damper is deformable in response to a pressure change in the supply tank. The second damper is deformable in response to a pressure change in the collection tank.

According to the above-described configuration, a variation in pressure is reduced by the tank including the damper structure. Bubbles generated in the tank are drained downstream by forward circulation of the liquid. Thus, the variation in pressure due to the bubbles can be reduced, and print abnormality can be prevented.

### Aspect 6

According to Aspect 6, in the liquid discharge head of any one of Aspects 1 to 3, the supply channel includes multiple curves. A cross section of a wall face of each of the multiple curves has curvature.

In other words, in the liquid discharge head of Aspect 3, the liquid channel connects: the supply port and the supply tank inlet of the supply tank; and the supply tank outlet of the supply tank and the liquid chamber. The liquid channel has a bent portion having a rounded corner.

Further, in the liquid discharge head of Aspect 4, the liquid channel connects: the discharge port and the collection tank outlet of the collection tank; and the collection tank inlet of the collection tank and the liquid chamber. The liquid channel has a bent portion having a rounded corner.

According to the above-described configuration, no liquid or bubbles remain at corner or edge. Thus, the variation in pressure due to the bubbles can be reduced, and print abnormality can be prevented.

### Aspect 7

According to Aspect 7, in the liquid discharge head of any one of Aspects 1 to 6, the supply tank and the collection tank each have a counter wall face opposite a wall face to which the inlet is formed and a counter wall face opposite a wall face to which the outlet is formed, and the counter wall faces each have a cross section forming a curved portion.

In other words, the supply tank has: a first curved portion having a first wall face curved with a first radius of curvature; and a second curved portion having a second wall face curved with a second radius of curvature. The first curved portion is disposed opposite to the second curved portion in a width direction orthogonal to the gravity direction. The first curved portion faces the supply tank inlet in the width direction. The second curved portion faces the supply tank outlet in the width direction.

Further, the collection tank has: a first curved portion having a first wall face curved with a first radius of curvature; and a second curved portion having a second wall face curved with a second radius of curvature. The first curved portion is disposed opposite to the second curved portion in the gravity direction. The first curved portion faces the collection tank inlet in the gravity direction. The second curved portion faces the collection tank outlet in the gravity direction.

According to the above-described configuration, no liquid or bubbles remain at corner or edge. Thus, the variation in pressure due to the bubbles can be reduced, and print abnormality can be prevented.

### Aspect 8

According to Aspect 8, in the liquid discharge head of any one of Aspects 1 to 7, the curved portion has a radius of curvature substantially identical to a maximum width of the supply tank or the collection tank.

In other words, the first radius of curvature and the second radius of curvature are equivalent to a maximum width of the supply tank in the width direction.

Further, the first radius of curvature and the second radius of curvature are equivalent to a maximum width of the collection tank in a width direction orthogonal to the gravity direction.

According to the above-described configuration, since the radius of curvature can be maximized without hindering the ink Q from flowing in the channels, no liquid or bubbles remain at corner or edge. Thus, the variation in pressure due to the bubbles can be reduced, and print abnormality can be prevented.

### Aspect 9

According to Aspect 9, in the liquid discharge head of any one of Aspects 1 to 8, a wall face of the damper structure includes an inclined face or a curved inclined face inclining toward the outlet as it goes upward in the direction of gravity.

In other words, the first damper has an inclined face inclined toward the supply tank outlet as the inclined face goes upward in the gravity direction.

Further, the second damper has an inclined face inclined toward the collection tank outlet as the inclined face goes upward in the gravity direction.

According to the above-described configuration, the volume of a portion surrounded by the supply tank and the damper structure decreases upward, and thus the flow speed of the liquid flowing inside increases to facilitate the drainage of bubbles.

### Aspect 10

According to Aspect 10, in the liquid discharge head of any one of Aspects 1 to 9, a portion surrounded by the damper structure has a cross-sectional area that decreases upward in the direction of gravity.

In other words, the supply tank has a cross-sectional area surrounded by the first damper on a plane orthogonal to the gravity direction, and the cross-sectional area decreases upward in the gravity direction.

Further, the collection tank has a cross-sectional area surrounded by the second damper on a plane orthogonal to the gravity direction, and the cross-sectional area decreases upward in the gravity direction.

According to the above-described configuration, the volume of a portion surrounded by the supply tank and the damper structure decreases upward, and thus the flow speed of the liquid flowing inside increases to facilitate the drainage of bubbles.

### Aspect 11

According to Aspect 11, in the liquid discharge head of Aspect 1, the liquid channel includes a first liquid channel and a second liquid channel. The supply tank inlet supplies the liquid from the first liquid channel, and the supply tank outlet discharges the liquid to the second liquid channel.

### Aspect 12

According to Aspect 12, in the liquid discharge head of Aspect 2, the liquid channel includes a first liquid channel, a second liquid channel, a third liquid channel, and a fourth liquid channel. The supply tank inlet supplies the liquid from the first liquid channel, the supply tank outlet discharges the liquid to the second liquid channel, the collection tank inlet collects the liquid from the third liquid channel, and the collection tank outlet discharges the liquid to the fourth liquid channel.

### Aspect 13

According to Aspect 13, an image forming apparatus includes the liquid discharge head of any one of Aspects 1 to 12.

In other words, an image forming apparatus includes the liquid discharge head according to any one of Aspects 1 to 12, to discharge the liquid to a medium and a conveyor to convey the medium to the liquid discharge head.

According to the above-described configuration, a variation in pressure can be reduced, and image abnormality can be prevented.

As described above, according to one aspect of the present disclosure, a tank disposed in the supply channel reduces a variation in pressure, and bubbles generated in the tank can be drained downstream by the forward circulation of liquid.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

1. A liquid discharge head comprising:
multiple nozzles to discharge a liquid;
a liquid channel communicating with the multiple nozzles, to flow the liquid through the liquid channel in a flow direction; and
a supply tank having:
a supply tank inlet to supply the liquid from the liquid channel into the supply tank; and
a supply tank outlet to discharge the liquid from the supply tank to the liquid channel toward the multiple nozzles in the flow direction; and
a supply port to supply the liquid to the supply tank inlet of the supply tank through the liquid channel,
wherein the supply tank is disposed between the supply port and the multiple nozzles in the liquid channel, and
the supply tank inlet is disposed below the supply tank outlet in a gravity direction.

2. The liquid discharge head according to claim 1, further comprising:
a collection tank having:
a collection tank inlet to collect the liquid from the multiple nozzles into the collection tank through the liquid channel; and
a collection tank outlet to discharge the liquid from the collection tank to the liquid channel in the flow direction; and
a discharge port to discharge the liquid from the liquid channel,
wherein the collection tank is disposed between the multiple nozzles and the discharge port in the liquid channel, and
the collection tank inlet is disposed below the collection tank outlet in the gravity direction.

3. The liquid discharge head according to claim 2, further comprising:
a nozzle plate having the multiple nozzles to discharge the liquid downward from the multiple nozzles in the gravity direction; and
a channel member over the nozzle plate, the channel member having a liquid chamber, which is a part of the liquid channel, communicating with the multiple nozzles,
wherein the supply port is disposed above the supply tank in the gravity direction, and
the supply tank is disposed above the channel member in the gravity direction and stores the liquid to be supplied to the liquid chamber through the supply tank outlet.

4. The liquid discharge head according to claim 3,
wherein the discharge port is disposed above the collection tank in the gravity direction, and
the collection tank is disposed above the channel member in the gravity direction and collects the liquid discharged from the liquid chamber through the collection tank inlet.

5. The liquid discharge head according to claim 2,
wherein the supply tank includes a first damper,
the collection tank includes a second damper,
the first damper is deformable in response to a pressure change in the supply tank, and
the second damper is deformable in response to a pressure change in the collection tank.

6. The liquid discharge head according to claim 3,
wherein the liquid channel connects:
the supply port and the supply tank inlet of the supply tank; and
the supply tank outlet of the supply tank and the liquid chamber, and
the liquid channel has a bent portion having a rounded corner.

7. The liquid discharge head according to claim 4,
wherein the liquid channel connects:
the discharge port and the collection tank outlet of the collection tank; and
the collection tank inlet of the collection tank and the liquid chamber, and
the liquid channel has a bent portion having a rounded corner.

8. The liquid discharge head according to claim 1,
wherein the supply tank has:
a first curved portion having a first wall face curved with a first radius of curvature; and
a second curved portion having a second wall face curved with a second radius of curvature,
the first curved portion is disposed opposite to the second curved portion in a width direction orthogonal to the gravity direction,
the first curved portion faces the supply tank inlet in the width direction, and
the second curved portion faces the supply tank outlet in the width direction.

9. The liquid discharge head according to claim 8,
wherein the first radius of curvature and the second radius of curvature are equivalent to a maximum width of the supply tank in the width direction.

10. The liquid discharge head according to claim 2,
wherein the collection tank has:
a first curved portion having a first wall face curved with a first radius of curvature; and
a second curved portion having a second wall face curved with a second radius of curvature,
the first curved portion is disposed opposite to the second curved portion in the gravity direction,
the first curved portion faces the collection tank inlet in the gravity direction, and
the second curved portion faces the collection tank outlet in the gravity direction.

11. The liquid discharge head according to claim 10,
wherein the first radius of curvature and the second radius of curvature are equivalent to a maximum width of the collection tank in a width direction orthogonal to the gravity direction.

12. The liquid discharge head according to claim 5,
wherein the first damper has an inclined face inclined toward the supply tank outlet as the inclined face goes upward in the gravity direction.

13. The liquid discharge head according to claim 5,
wherein the supply tank has a cross-sectional area surrounded by the first damper on a plane orthogonal to the gravity direction, and
the cross-sectional area decreases upward in the gravity direction.

14. The liquid discharge head according to claim 5,
wherein the second damper has an inclined face inclined toward the collection tank outlet as the inclined face goes upward in the gravity direction.

15. The liquid discharge head according to claim 5,
wherein the collection tank has a cross-sectional area surrounded by the second damper on a plane orthogonal to the gravity direction, and
the cross-sectional area decreases upward in the gravity direction.

16. The liquid discharge head according to claim 1,
wherein the liquid channel includes a first liquid channel and a second liquid channel,
the supply tank inlet supplies the liquid from the first liquid channel, and
the supply tank outlet discharges the liquid to the second liquid channel.

17. The liquid discharge head according to claim 2,
wherein the liquid channel includes a first liquid channel, a second liquid channel, a third liquid channel, and a fourth liquid channel,
the supply tank inlet supplies the liquid from the first liquid channel,
the supply tank outlet discharges the liquid to the second liquid channel,
the collection tank inlet collects the liquid from the third liquid channel, and
the collection tank outlet discharges the liquid to the fourth liquid channel.

18. An image forming apparatus comprising:
the liquid discharge head according to claim 1, to discharge the liquid to a medium; and
a conveyor to convey the medium to the liquid discharge head.
